(19) United States
(12) Patent Application Publication
(10) Pub. No.: US 2016/0023936 A1
(43) Pub. Date: Jan. 28, 2016

(54) METHOD FOR CHARGING A GLASS MELTING PLANT WITH BULK MATERIAL MADE UP OF SHARDS AND RAW MATERIAL BATCH, AND DEVICE FOR CARRYING OUT THE METHOD

(71) Applicant: Beteiligungen Sorg GmbH & Co. KG, Lohr am Main (DE)

(72) Inventors: Matthias Lindig, Ingelheim (DE); Karl Bonfig, Zell am Main (DE); Clemens Eidmann, Wuerzburg (DE)

(21) Appl. No.: 14/809,763

(22) Filed: Jul. 27, 2015

(30) Foreign Application Priority Data
Jul. 28, 2014 (DE) 1020140109143

(51) Int. Cl. C03B 3/02; C03B 1/00; C03B 3/00

(52) U.S. Cl. CPC C03B 3/023; C03B 3/00; C03B 1/00

(57) ABSTRACT

A method and a device for charging glass melting plants with bulk materials comprising shards and primary raw materials (raw material batch). The bulk materials are stocked in a silo in which they slide downward due to their weight, then through an outlet onto a device that conveys them to the glass melting plant. The silo has two separate supply containers, a first container accommodates the shards and the second container accommodates the raw material batch. The raw material batch is force-conveyed into the first container via a dosing device situated underneath the outlet of the second container. From the outlet of the first container there exits a mixture of the shards stored in the first container and the raw material batch supplied from the second container. The two combined components are conveyed by at least one withdrawal device to the point of delivery to the glass melting plant.

### CROSS-REFERENCES TO RELATED APPLICATIONS

This application claims the benefit of the German patent application No. 10 2014 010 914.3 filed on Jul. 28, 2014, the entire disclosures of which are incorporated herein by way of reference.

### BACKGROUND OF THE INVENTION

The present invention relates to a method for charging a glass melting plant with bulk material made up of shards and raw material batch, and to a device for carrying out the method.

In the production of glass products, the melt material continuously fed to the glass melting plant is made up of shards and primary raw materials (raw material batch). The shards can originate from recirculation of faulty production cycles, and/or can be so-called recycling shards.

The supply of the shards to the melt process has an important positive influence on the melt characteristic and energy consumption of the glass melting plant. The addition of shards accelerates the overall melting process and reduces the amount of energy required. The mixture made up of the raw material batch alone, without the addition of shards, requires a significantly higher amount of energy for the production of the glass melt. 10 wt % addition of shards reduces the energy requirement in the production of container glass by approximately 3%. However, here it is necessary that the ratio of raw material batch and shards be controlled and maintained within a narrow range of variation. Fluctuations in this ratio would also cause a fluctuating melt energy requirement.

As a rule, in an open system the ratio is set via dosing screws, or via simple weighing. The silo before the glass melt plant is correspondingly charged with the shards and the raw material batch for storage. The two components are situated in layers on one another in the silo. When they are withdrawn, there occurs an adequate mixing of the two components.

A further savings of energy can be achieved in that, via a heat exchanger, heat from the hot exhaust gases of the glass melting plant is supplied to the shards and to the raw material batch.

If a high portion of shards is available, it makes sense in terms of cost to transfer the useful heat only to the stream of shards. In this case, however, the shards have to be separated from the second component, the raw material batch, until the delivery to the glass melting plant. Moreover, before entry into the glass melting plant the material streams must be brought together with a particular mass ratio. In this case, an open weighing is ruled out, because then the pre-heated shards would lose heat. In addition, significant dust contamination would occur in the area of the delivery and mixture.

### SUMMARY OF THE INVENTION

Therefore, an object of the present invention is to create a method and a device with which shards, in particular hot shards, and a raw material batch can be brought together before the delivery point of the two material streams to the glass melting plant, with a particular quantity ratio and while avoiding significant contamination by dust in the delivery area.

According to the teaching of the method of the present invention, the two material streams, made up of shards and raw material batch, are brought together from two separate supply containers (first and second supply container), in a continuous throughput process. Here, a significant inventive feature is that the raw material batch is force-conveyed from its supply container (second supply container) directly into the shard supply container (first supply container), by means of a sealed, dust-tight dosing device. During this, not only can the quantity ratio of the two material streams be adjusted to one another relatively precisely, but in this way an undesirable development of dust is also prevented.

It has proven advantageous to supply heat from the hot exhaust gases of the glass melting plant to the first supply container for the shards via a heat exchanger. In this way, the shards can be pre-heated, resulting in a significant savings of energy.

In order to facilitate the setting and maintenance of a particular quantity ratio between the two material streams, according to the present invention it is provided that during each conveying via the simultaneously operating dosing device, the withdrawal device underneath the first supply container for the shards also carries along, in addition to the shards sliding downward in the container, raw material batch from the second supply container thereof, in a particular mass ratio.

According to the present invention, it is provided that the device between the first supply container and the second supply container has a withdrawal and conveying device (dosing device) for the dosing of the raw material batch into the first supply container. The dosing device is situated underneath the outlet of the second supply container. By means of the dosing device, the raw material batch is force-conveyed into the first supply container.

It has proven useful that the overall withdrawn quantity of the mixture of shards and raw material batch is regulated through a measurement of the level of the glass melt in the glass melt tub using a level sensor during the subsequent continuously operating throughput process (production quantity).

According to a specific embodiment of the present invention, it is provided that the remaining requirement of the overall withdrawn quantity is covered by free afterflow of the material in the supply container for the shards.

In addition, it has proven advantageous that the raw material batch force-conveyed from the supply container is dosed directly into the withdrawal funnel of the supply container for the shards.

A particular advantage of the device according to the present invention is that the dosing device with which the raw material batch is supplied into the first supply container for the shards is outwardly sealed. In this way, an undesirable development of dust is avoided.

The supply of the raw material batch to the shard flow is facilitated according to the present invention in that in the first supply container for the shards the dosing device that includes the supply line of the raw material batch is covered by a roof-shaped cover. In this way, the force-conveyed raw material stream can fall unhindered into the shard flow.

Depending on the required throughput performance of the glass melt plant, the second supply container for the raw material batch can, according to the present invention, also have two or more outlets. Usefully, in this case, for each outlet in the second supply container for the raw material batch a supply line for the dosing of the raw material batch is fashioned in the first supply container for the shards.

In addition, it has proven advantageous that the first supply container for the shards tapers downward into two or more separate shafts for conducting partial streams of the charging material. In this way, the raw material batch is still more effectively carried along by the shard flow.

The dosing of the raw material batch to the shard flow can take place in a manner dependent on the local conditions and the required throughput performance at various locations. Thus, the dosing can take place directly into the shard flow. However, according to the present invention the dosing of the raw material batch can also take place centrically between two partial streams of the shard flow. Finally, the dosing of the raw material batch can also take place laterally to the shard flow.

It has proven particularly advantageous that the dosing device has at its end situated before the withdrawal point, i.e., at the end situated in the direction of the first supply container, a funnel-shaped supply channel, preferably having the roof-shaped covering mentioned above, which supply channel directs the raw material batch in the vertical direction and supplies it vertically to the shard flow. In particular, the supply channel can have an elliptical, rectangular cross-section (in the horizontal direction) or a polygon-shaped cross-section (in the horizontal direction). This brings it about that the raw material batch is better distributed in the mixture, and is better deposited over the width of the cross-section in the shard flow. It is particularly advantageous if the supply channel causes the formation of a shard cone below the end of the supply channel (withdrawal point), for example through a corresponding realization of the shape of the underside of the supply channel. Such a shard cone forces the withdrawn raw material batch to flow laterally to the left and to the right on the cone, so that a still better distribution of the raw material batch in the mixture is achieved. For this purpose, the lower side can for example have an indentation or narrowing that is directed upward and that runs with a round or angled shape.

Moreover, it is advantageous if at least two withdrawal devices are provided that are situated alongside one another in the horizontal direction. These can convey the mixture in the direction of the glass melting plant over a larger width. In particular in this specific embodiment, the above-indicated realization of the dosing device having the funnel-shaped supply channel is advantageous.

Further embodiments of the present invention are described in the subclaims.

### BRIEF DESCRIPTION OF THE DRAWINGS

Further features, advantages, and possible applications of the present invention result from the following description of exemplary embodiments, shown in the drawing.

FIG. 1 shows, in a diagram, a regulation schema of the charging device according to the present invention,

FIG. 2 shows a longitudinal section through a first specific embodiment of a charging device according to the present invention,

FIG. 3 shows a cross-section through the charging device of FIG. 2,

FIG. 4 shows a section along the line AA through the charging device of FIG. 2,

FIG. 5 shows a cross-section through a second specific embodiment of a charging device according to the present invention,

FIG. 6 shows a cross-section through a third specific embodiment of a charging device according to the present invention,

FIG. 7 shows a cross-section through a fourth specific embodiment of a charging device according to the present invention,

FIG. 8 shows a longitudinal section (see AA in FIG. 9) through a fifth specific embodiment of a charging device according to the present invention,

FIG. 9 shows a cross-section through the charging device shown in FIG. 8,

FIG. 10 shows a section along BB (see FIG. 8) through the charging device of FIGS. 8 and 9,

FIG. 11 shows an alternative possibility for the realization of the supply channel in a longitudinal section analogous to FIG. 8, and

FIG. 12 shows a further alternative possibility for the realization of the supply channel in a longitudinal section, analogous to FIG. 8.

### DETAILED DESCRIPTION OF THE PREFERRED EMBODIMENTS

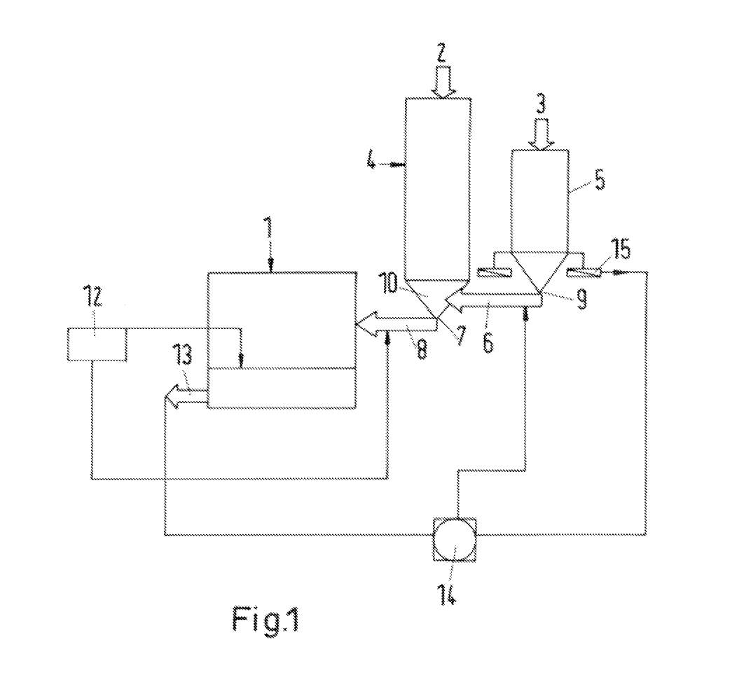

The regulating schema shown in FIG. 1 illustrates the design and functioning of the device for charging a glass melting plant 1 with bulk material made up of shards 2 and primary raw materials (raw material batch) 3. The silo for storing the charging material is made up of two supply containers 4 and 5. The first supply container 4 accommodates the shards 2, while the second supply container 5 accommodates the raw material batch 3.

A withdrawal and conveying device (referred to hereinafter as dosing device) 6 is situated between the first supply container 4 for the shards 2 and the second supply container 5 for the raw material 3. This dosing device 6 conveys the raw material batch 3 directly into the supply container 4 for the shards. Under an outlet 7 of the first supply container 4 there is situated a further withdrawal device 8 that further conveys the charging material to the point of delivery to the glass melting plant 1.

The first supply container 4 is fed, by a heat exchanger (not shown), with hot exhaust gases from the glass melting plant 1. In this way, the shards 2 in the first supply container 4 are pre-heated.

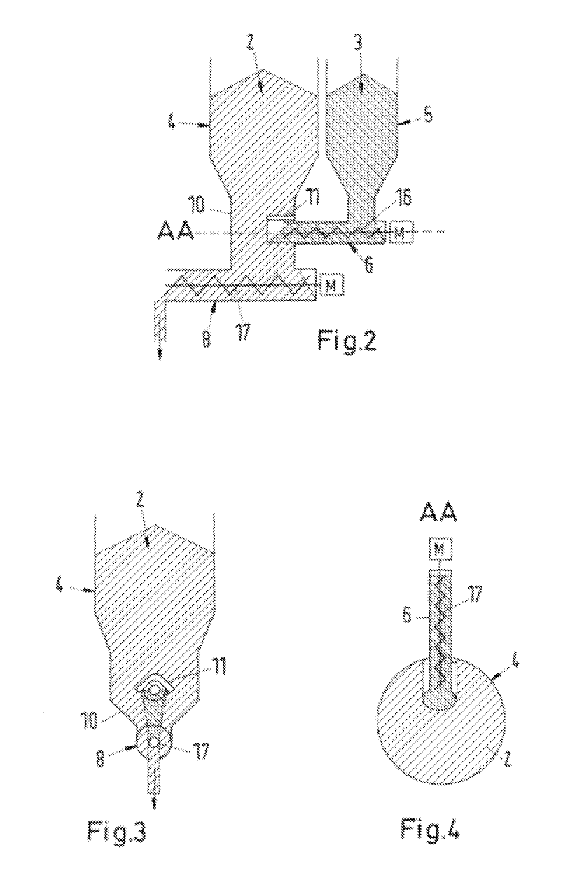

The raw material batch 3 fed into the second supply container 5 from above slides downward therein, and flows through an outlet 9 onto the dosing device 6. This device conveys the raw material batch 3 directly into a withdrawal funnel 10 of the first supply container 4 for the shards 2. As can be seen in FIGS. 2 and 3, the supply line of the raw material batch flow 3 is covered with a roof-shaped covering 11 in the supply container 4, so that the force-conveyed raw material batch 3 can fall unhindered into the shard flow 2.

The discharging of the mixture of the shards 2 and the raw material batch 3 takes place in the outlet 7 of the supply container 4, by means of a withdrawal device 8. The overall withdrawn quantity 13 is regulated through a measurement of the level of the glass melt in the glass melting tub (not shown in more detail), using a level sensor 12 that is positioned in the subsequent throughput process (production quantity). The withdrawal device 8 conveys the mixture of the dosed raw material batch 3, based on its supplying by the dosing device 6 from the second supply container 5, and the freely afterflowing shards 2 from the first supply container 4, to the point of delivery to the glass melt tub. During each conveying via the simultaneously operating dosing device 6, the withdrawal device 8 always carries the raw material batch 3 along. The remaining amount of the required overall withdrawn quantity 13 is covered through free afterflow of the material in the first supply container 4.

The mixture ratio between the shards 2 and the raw material batch 3 is calculated and monitored using a process control system 14 that is not shown and described in more detail. The portion of the raw material batch 3 in the overall withdrawn quantity 13 can be freely selected, and is inputted into a process control system 14 as a percentual value of the overall withdrawn quantity 13. The withdrawn quantity per time unit for the raw material batch 3 is acquired via weight load cells 15 on which the second supply container 5 stands.

FIGS. 2 through 7 show schematic representations of various specific embodiments of the supply containers and of the withdrawal devices. Identical components have been provided with identical reference characters.

FIGS. 2 through 4 illustrate, on the basis of a first specific embodiment, the interaction of the first supply container 4 for the shards 2 and the second supply container 5 for the raw material batch 3 with the associated withdrawal and conveying devices 6 and 8. The functioning of the device is as follows:

For the charging of glass melting plants with charging material made up of shards and a mixture of raw material batch, the glass shards are brought into the first supply container 4, and the raw material batch is brought into the second supply container 5. The raw material batch 3, supplied from above, slides downward in the second supply container 5, and falls through the outlet 9 onto the dosing device 6, which, by means of a screw driven by a motor M, conveys the raw material batch 3 directly into the withdrawal funnel 10 of the first supply container 4.

There, the supply line for the raw material batch 3 is covered by a roof-shaped covering 11. In this way, the force-conveyed raw material batch flow 3 can fall unhindered into the shard flow 2. Here, the dosing device 6 is connected to the second supply container 5 in such a way that both are outwardly sealed. Because the supply line for the raw material batch to the first supply container 4 is also largely outwardly sealed, the dosing device 6 is as a whole a closed system, with the consequence that dust contamination at the delivery points is greatly reduced.

The mixture, brought together in the first supply container 4, of the shards 2 and the raw material batch 3 exits from the outlet 7 and is conveyed by the withdrawal device 8 to the point of delivery to the glass melting plant 1. There, during each conveying via the simultaneously operating dosing device 6, in addition to the shards 2 sliding downward in the container the withdrawal device 8 also carries along the raw material batch 3 from the second supply container 5 (force-guiding), in a specified mass ratio.

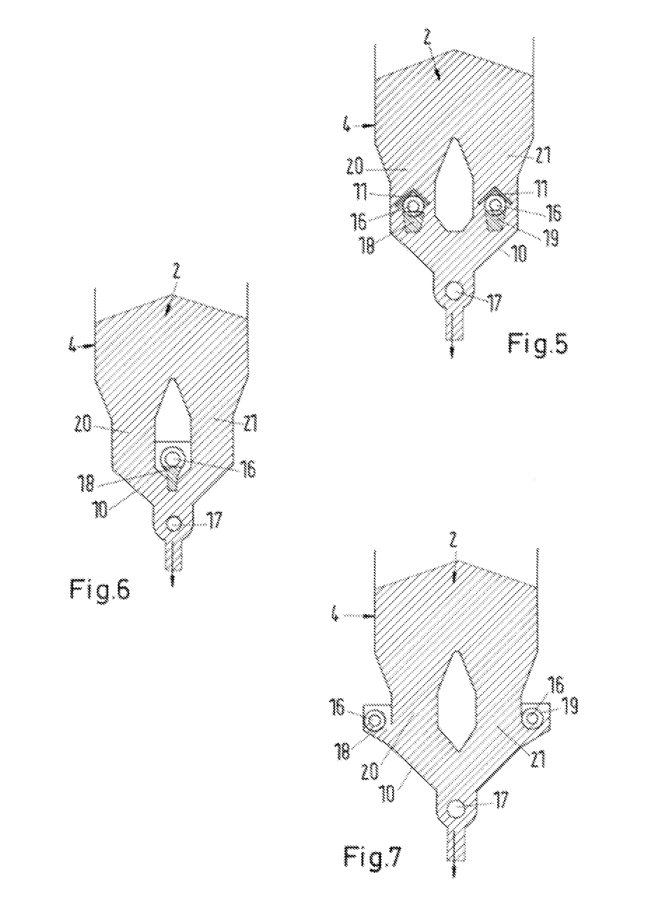

The first supply containers 4 shown in FIGS. 5 through 7 taper downward into two separate shafts 20 and 21, through which partial streams of the charging material are conducted.

The second supply containers 5 can have two or more outlets, as a function of the throughput performance of the glass melt plants 1. For each outlet in the supply container 5, corresponding supply lines 18 and 19 are provided in the first supply container 4.

In the first supply container 4 shown in FIG. 5, two supply lines 18 and 19, coming from the second supply container 5, extend respectively into one of the two shafts 20 and 21 of the downward-tapering withdrawal funnel 10. In this specific embodiment, the raw material batch 3 is dosed into the shard flow.

In the specific embodiment according to FIG. 6, the dosing of the raw material batch 3 takes place centrically between two partial streams of the shard flow 2. In this specific embodiment, the dosing does not require a covering. This holds in the same way for the specific embodiment according to FIG. 7, in which the dosing of the raw material batch 3 takes place laterally to the shard flow 2.

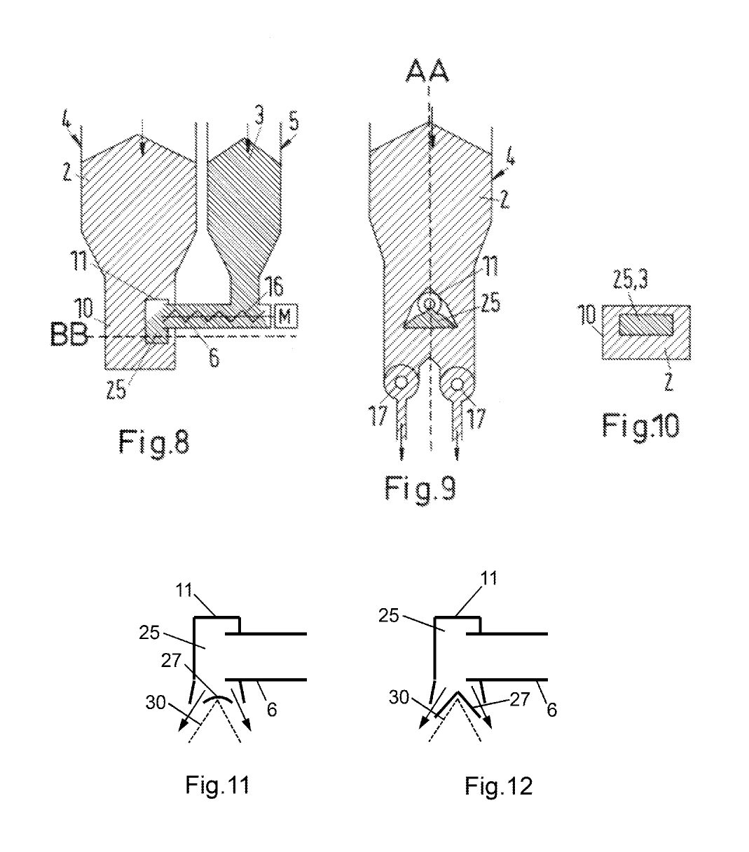

In the specific embodiment shown in FIGS. 8 through 10 of a charging device according to the present invention, at the end of the dosing device 6 oriented toward the first supply container 4 there is situated a supply channel that diverts the flow of the raw material batch 3 in such a way that this flow is supplied to the shard flow 2 in the vertical direction. On the supply channel there is provided a covering 11 that prevents interruption of the flow of the raw material batch 3 by the shard flow 2. In particular, the supply channel is realized with a funnel shape (see FIG. 9). In this way, it is enabled that the raw material batch 3 is deposited more broadly into the shard flow 2.

As can be seen in FIG. 9, this specific embodiment has two withdrawal devices 8 situated alongside one another in the horizontal direction (each having a conveyor screw 17), so that the mixture can be conveyed over a larger width in the direction of the glass melting plant.

FIGS. 11 and 12 show variants of the embodiment of the supply channel 25; here the section corresponds to the section in FIG. 8. Each supply channel has on its underside 27 a round (see FIG. 11) or angled (see FIG. 12) indentation (cutout) that is oriented upward, and which brings it about that the shards of the shard flow 2 surrounding the funnel of supply channel 25 flow together again underneath the supply channel 25 in such a way that a shard cone 30 (see dashed lines) is formed underneath the dropoff point. This shard cone 30 forces the dropped raw material batch 3 to flow laterally to the left and to the right onto the shard cone 30 (see arrows in FIGS. 11 and 12). In this way, a particularly good distribution of the raw material batch 3 in the mixture is brought about.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

### LIST OF REFERENCE CHARACTERS

1 glass melting plant/glass melt tub

2 shards, shard flow

3 raw material batch, raw material batch flow

4 first supply container (for shards)

5 second supply container (for raw material batch)

6 dosing device (withdrawal and conveying device) between 4 and 5

7 outlet of 4

8 withdrawal device under 7

9 outlet of 5

10 withdrawal funnel of 4

11 roof-shaped covering

12 level sensor

13 overall withdrawn quantity

14 process control system

15 weight load cell

16 screw of dosing device 6

17 screw of withdrawal device 8

18 supply line in 4

19 supply line in 4

20 shaft in 4

21 shaft in 4

25 supply channel

27 underside of the supply channel

30 shard cone

M motor

1. A method for charging glass melting plants with bulk materials made up of shards and primary raw materials (raw material batch) as components for melt material, the bulk materials being stocked in a silo in which they slide downward due to their weight, where they move through an outlet onto a conveying device that conveys them to the glass melting plant, comprising the steps:
providing a first container as a part of the silo to accommodate the shards and a second container as a part of the silo to accommodate the raw batch material,
force-guiding the raw material batch into the first supply container for the shards via a dosing device situated underneath an outlet of the second supply container, and
dispensing a mixture of the shards stored in the first supply container and the raw material batch supplied from the second supply container from an outlet of the first supply container,
conveying the two combined components of the melt material to a point of delivery to the glass melting plant by at least one withdrawal device positioned between the first supply container and the glass melting plant.

2. The method as recited in claim 1, including a step of supplying heat from the hot exhaust gases of the glass melting plant via a heat exchanger to the first supply container for the shards, and using the heat to pre-heat the shards.

3. The method as recited in claim 1, wherein during the conveying step the force-guiding step is occurring simultaneously, such that the withdrawal device underneath the first supply container also carries along, in addition to the shards sliding downward in the first supply container, raw material batch provided in a specified mass ratio from the second supply container.

4. The method as recited in claim 1, including a step of regulating an overall withdrawn quantity of the mixture of shards and raw material batch through a measurement of a level of a glass melt in a glass melt tub of the glass melting plant using a level sensor during a continuously operating throughput process.

5. The method as recited in claim 1, wherein a remaining requirement for the overall withdrawn quantity is covered by free afterflowing of the material in the first supply container.

6. The method as recited in claim 1, wherein the step of force-guiding raw material batch from the second supply container is performed by dosing the raw material batch into a withdrawal funnel of the first supply container.

7. A device for charging a glass melting plant with bulk materials made up of shards and primary raw materials (raw material batch), comprising:
a silo for the charging material and having a conveying device for supplying the charging material into the glass melting plant,
the silo comprising two separate supply containers, a first supply container configured to receive the shards and the second supply container configured to receive the raw material batch,
a dosing device for dosing the raw material batch into the first supply container being situated between the first supply container and the second supply container,
at least one withdrawal device located under an outlet of the first supply container for the mixture of the shards stored in the first supply container and the raw material batch supplied from the second supply container, the withdrawal device being configured and arranged to convey the two combined components of the melt material to a point of delivery to the glass melting plant.

8. The device as recited in claim 7, wherein the first supply container for the shards comprises a heat exchanger that configured to receive hot exhaust gases from the glass melting plant.

9. The device as recited in claim 7, wherein the withdrawal device of the first supply container is configured and arranged to carry along raw material batch that has been transferred to the first supply container from the second supply container by the dosing device.

10. The device as recited in claim 7, wherein the dosing device is connected to the first supply container in an outwardly sealed and dust-tight manner.

11. The device as recited in claim 7, wherein the dosing device for the raw material batch is covered by a roof-shaped covering within the first supply container for the shards.

12. The device as recited in claim 7, wherein the dosing device is configured such that force-conveyed raw material batch flow falls unhindered into a shard flow in the first supply container.

13. The device as recited in claim 7, wherein the second supply container for the raw material batch has two or more outlets.

14. The device as recited in claim 7, wherein for each outlet of the second supply container a supply line for the dosing of the raw material batch there is arranged in the first supply container.

15. The device as recited in claim 7, wherein the first supply container tapers downward into two or more separate shafts for the conducting of partial streams of the charging material.

16. The device as recited in claim 7, wherein the dosing device is configured and arranged to dose the raw material batch directly into a flow of the shard within the first supply container.

17. The device as recited in claim 7, wherein the first supply container is configured and arranged to provide two partial streams of a flow of shard therethrough and the dosing device is configured and arranged to dose the raw material batch centrically between the two partial streams of the shard flow within the first supply container.

18. The device as recited in claim 7, wherein the raw material batch is dosed laterally to a flow of shard within the first supply container.

19. The device as recited in claim 7, wherein the dosing device comprises a funnel-shaped supply channel that deflects the raw material in a vertical direction and supplies the raw material vertically into a flow of shard within the first supply container.
